(19) United States
(12) Patent Application Publication
(10) Pub. No.: US 2008/0214766 A1
(43) Pub. Date: Sep. 4, 2008

(54) Binder combinations based on polyacrylate dispersions

(75) Inventors: Thomas Munzmay, Dormagen (DE); Sandra Hackbarth, Bedburg (DE); Martin Melchiors, Leichlingen (DE); Heinz-Dietmar Gewiss, Meerbusch (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 12/072,815

(22) Filed: Feb. 28, 2008

(30) Foreign Application Priority Data
Mar. 2, 2007 (DE) 102007010660.4

(51) Int. Cl. C08F 120/18

(52) U.S. Cl. 526/329.7

(57) ABSTRACT

Aqueous polyacrylate dispersions comprising hydrophobic co-solvents are provided. The dispersions are prepared from copolymers P) which are comprised of I) a hydroxy-functional, hydrophobic polymer containing as structural monomers Ia) (meth)acrylic acid esters having from C₁- to C₁₈-hydrocarbon radicals in the alcohol part and/or vinyl aromatic compounds and/or vinyl esters and Ib) hydroxy-functional monomers; and II) a hydroxy-functional, hydrophilic polymer containing as structural components IIa) (meth)acrylic acid esters having from C₁- to C₁₈-hydrocarbon radicals in the alcohol part and/or vinyl aromatic compounds and/or vinyl esters, IIb) hydroxy-functional monomers and IIc) acid-functional monomers, and as solvents C) one or more solvents selected from the group consisting of hydrophobic, water-immiscible hydrocarbons having an initial boiling point of from 170° C. to 250° C. and a dry point of from 200° C. to 280° C., to a process for their preparation and to their use as binders for the production of blister-free coatings.

### CROSS-REFERENCE TO RELATED APPLICATION

This application claims priority under 35 U.S.C. §119 (a-d) to German application Serial No. DE 10 2007 010660.4, filed Mar. 2, 2007.

### FIELD OF THE INVENTION

The invention relates to aqueous polyacrylate dispersions comprising hydrophobic co-solvents, to a process for their preparation and to their use as binders for the production of popping-free coatings.

### BACKGROUND OF THE INVENTION

It is known from a large number of publications and patents to use dispersions based on polyacrylate dispersions in water-dilutable lacquers and coating systems.

EP-A 947 557 describes the use of “special solvent mixtures” consisting of a hydrophobic, water-immiscible, non-saponifiable solvent and a water-miscible or water-soluble, non-saponifiable solvent as co-solvent in acrylate polymerisation.

When applying any lacquers to a substrate, air is enclosed in the lacquer film in dissolved form or in the form of microbubbles. As the lacquer dries and solvents and/or water escape, bubbles form or the microbubbles that are present grow. Some of these bubbles dissolve in the lacquer polymer again, others rise to the surface of the lacquer and escape (rise & rupture model). At a particular film thickness, some of the bubbles can no longer escape completely and visible defects in the lacquer film form, such as, for example, blisters, pinholes and craters. The film thickness at which this phenomenon occurs is referred to as the popping limit. The popping limit is an important quality feature for the processing reliability of a lacquer.

The popping limit of aqueous two-component (2K) polyurethane (PUR) lacquers according to the prior art is from 60 to 80 μm (see W. Hovestadt & E. Jürgens (1999) —Blasenfreie Applikation wässriger 2K-PUR-Lacke. In: Farbe & Lack August 99: 30-37 and WO-A 2002/079296). However, in particular when lacquering three-dimensional parts, regions in which lacquer layer thicknesses greater than the mentioned 60 to 80 μm occur are always formed as a result of flow effects. When aqueous 2K PUR lacquers according to the prior art are used, blisters can then occur in the lacquer, which lead to noticeable faults in the lacquer surface and hence to a reduction in the quality of the lacquered parts.

There was therefore an urgent need for aqueous dispersions which can be processed to 2K PUR lacquers having a higher popping limit. These lacquers are to be based on dispersions which, owing to reactive groups, are capable, even at room temperature, of curing to high-quality coatings with suitable crosslinkers. Moreover, the dispersions are to have a high solids content and excellent storage stability, both as a dispersion and in the lacquer. The lacquer films are additionally to exhibit very good resistance properties to solvents, water and environmental influences.

### SUMMARY OF THE INVENTION

The object of the present invention was, therefore, to provide aqueous polymer dispersions which can be processed to aqueous 2K PUR lacquers having a higher blister-free layer thickness and which satisfy the properties required above.

Surprisingly, it has now been found that polyacrylate-polyol dispersions which contain special, hydrophobic hydrocarbons as co-solvents are outstandingly suitable for the production of aqueous 2K PUR lacquers having a markedly higher blister-free layer thickness.

This was not to be expected, because it is noted in DE-A-3 022 824, for example, in which water-dilutable copolymers are described, that water-immiscible solvents impair the dilutability of the binders in water, so that an addition of such solvents is not to be recommended. This prejudice is also supported by the fact that in the prior art cited above, the described solvents are not used in any of the exemplary embodiments.

The present invention therefore provides aqueous polyacrylate dispersions comprising copolymers P) which are composed of
I) a hydroxy-functional, hydrophobic polymer containing as structural monomers
   Ia) (meth)acrylic acid esters having from C₁- to C₁₈-hydrocarbon radicals in the alcohol part and/or vinyl aromatic compounds and/or vinyl esters and
   Ib) hydroxy-functional monomers as well as
II) a hydroxy-functional, hydrophilic polymer containing as structural components
   IIa) (meth)acrylic acid esters having from C₁- to C₁₈-hydrocarbon radicals in the alcohol part and/or vinyl aromatic compounds and/or vinyl esters,
   IIb) hydroxy-functional monomers and
   IIc) acid-functional monomers,
      and as solvents C) one or more solvents selected from the group consisting of hydrophobic, water-immiscible hydrocarbon which has an initial boiling point (according to ASTM D86-05) of from 170° C. to 250° C., preferably from 180° C. to 230° C., and a dry point (according to ASTM D86-05) of from 200° C. to 280° C., preferably from 200° C. to 260° C.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The copolymer P) can optionally contain as a further polymerisation stage a hydroxy-functional, hydrophobic copolymer II′) based on hydroxy- and/or non-functional (meth)acrylic acid esters or vinyl aromatic compounds as structural component. This is carried out in situ by copolymerisation of the monomers following the preparation of the copolymer II).

Suitable monomers Ia)/IIa) are, for example, ethyl acrylate, n-butyl acrylate, isobutyl acrylate, tert-butyl acrylate, 2-ethylhexyl acrylate, methyl methacrylate, n-butyl methacrylate, styrene, vinyltoluene, ethyl methacrylate, 2-ethylhexyl methacrylate, α-methylstyrene and mixtures of these and other monomers. Preferred (meth)acrylic acid esters a) are those having linear- or branched-aliphatic hydrocarbon radicals having from 1 to 18, particularly preferably from 1 to 8, carbon atoms. Vinyl esters can optionally be used concomitantly.

Further suitable monomers Ia)/IIa) are the esterification products of vinyl alcohol with linear or branched, aliphatic carboxylic acids, such as, for example, vinyl acetate, vinyl propionate, vinyl butyrate, vinyl 2-ethylhexanoate, vinyl octanoate, vinyl decanoate, vinyl dodecanoate (vinyl laurate) or vinyl stearate. Preference is given to the vinyl esters of branched, aliphatic carboxylic acids of the general formula (I)

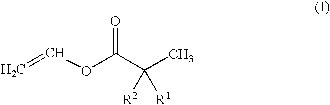

wherein R¹ and R² are saturated alkyl groups together containing 6, 7 or 8 carbon atoms, corresponding to the compounds VeoVa™ 9, 10 and 11.

The mentioned monomers differ in respect of the glass transition temperature of their homopolymers:

| Monomer | T_{G} [° C.] |
|---|---|
| VeoVa ™ 9 | +70 |
| VeoVa ™ 10 | −3 |
| VeoVa ™ 11 | −40 |

Further monomers capable of free-radical copolymerisation can optionally also be used as compounds of component Ia)/IIa) in the preparation of copolymer I). These can be, for example, derivatives of acrylic or methacrylic acid, such as acrylamide, methacrylamide, acrylonitrile or methacrylonitrile. Vinyl ethers or vinyl acetates are further possible. Suitable further components Ia)/IIa) that are optionally to be used in subordinate amounts are di- or higher-functional (meth)acrylate monomers and/or vinyl monomers, such as, for example, hexanediol di(meth)acrylate or divinylbenzene. Polymerisable hydroxy-functional monomers having a number-average molecular weight ≦3000 g/mol, preferably ≦500 g/mol, and modified or chain-lengthened with alkylene oxides can likewise be used in Ia)/IIa). As alkylene oxides there are preferably used in this connection ethylene, propylene or butylene oxide, individually or in mixtures.

Suitable hydroxy-functional monomers Ib)/IIb) are, for example, 2-hydroxyethyl methacrylate, 2-hydroxypropyl methacrylate, 2-hydroxyethyl acrylate, 2-hydroxy-propyl acrylate, 4-hydroxybutyl acrylate, 4-hydroxybutyl methacrylate. Preferred monomers b) are 2-hydroxyethyl methacrylate, 2-hydroxypropyl methacrylate or 4-hydroxybutyl acrylate as well as mixtures of these compounds.

Suitable olefinically unsaturated, acid-functional monomers IIc) are sulfonic- or carboxylic-acid-functional monomers, preferably carboxylic-acid-functional monomers such as acrylic acid, methacrylic acid, β-carboxyethyl acrylate, crotonic acid, fumaric acid, maleic anhydride, itaconic acid or monoalkyl esters of dibasic acids or anhydrides, such as, for example, maleic acid monoalkyl esters; preference is given to acrylic or methacrylic acid. Also suitable as compounds of component IIc) are unsaturated, free-radically polymerisable compounds having phosphate, or phosphonate, or sulfonic acid, or sulfonate, groups, as are described, for example, in WO-A 00/39181 (p. 8, line 13-p. 9, line 19). 2-Acrylamido-2-methylpropanesulfonic acid is preferred.

The proportion of the monomers Ia)/IIa) in the copolymer P) is from 23 to 89.4 wt. %, preferably from 48 to 85.3 wt. % and particularly preferably from 56.5 to 81.5 wt. %, the proportion of the monomers Ib)/IIb) in the copolymer P) is from 10 to 65 wt. %, preferably from 13.5 to 46.5 wt. % and particularly preferably from 17 to 40 wt. %, and the proportion of the monomers IIc) in the copolymer P) is from 0.6 to 12 wt. %, preferably from 1.2 to 5.5 wt. % and particularly preferably from 1.5 to 3.5 wt. %.

The acid-functional monomers IIc) are used in an amount such that the copolymer P) has an acid number of from 5 to 55 mg KOH/g solid, preferably from 10 to 35 mg KOH/g solid and particularly preferably from 12.5 to 27.5 mg KOH/g solid.

The proportion of the hydroxy-functional, hydrophobic graft base I) in the copolymer P) is from 50 to 95 wt. %, preferably from 75 to 90 wt. %, and the proportion of the hydroxy-functional, hydrophilic polymer II) in the copolymer P) is from 5 to 50 wt. %, preferably from 10 to 25 wt. %.

The procedure for polymerisation of the unsaturated monomers is known per se to the person skilled in the art. To this end, a hydrophobic, water-immiscible hydrocarbon mixture C is typically placed in a reaction vessel and the unsaturated monomers are polymerised in the fed batch process using a free-radical initiator. In the preferred form of the process, a two-stage addition and polymerisation of the monomer mixtures I) and II) in the mentioned sequence takes place. In a first step (i), a hydroxy-functional, hydrophobic graft base I) having an OH number of from 12 to 250 mg KOH/g solid, preferably from 50 to 200 mg KOH/g solid, is prepared from the monomers Ia) and Ib). In a subsequent step (ii), the hydroxy-functional, hydrophilic polymer II) is prepared from the monomers Ia) to IIc) in the solution of the graft base I) obtained from step (i), this hydroxy-functional, hydrophilic polymer having an OH number of from 20 to 250 mg KOH/g solid, preferably from 120 to 220 mg KOH/g solid, and an acid number of from 50 to 250 mg KOH/g solid, preferably from 110 to 200 mg KOH/g solid.

The preparation of the copolymer P) is carried out by a free-radical-initiated copolymerisation of the monomer mixture I) and II) in organic solvent mixtures C). The amount of organic solvents C) is such that the resulting solutions of the copolymers have a solids content of from 95 to 60 wt. %, preferably from 92.5 to 80 wt. %.

Suitable co-solvents C) are aliphatic or aromatic hydrocarbons having an initial boiling point (according to ASTM D86-05) of from 170° C. to 250° C., preferably from 180° C. to 230° C., and a dry point (according to ASTM D86-05) of from 200° C. to 280° C., preferably from 200° C. to 260° C.

TABLE 1
Co-solvents C)

| | | | Dry point |
|---|---|---|---|
| Hydrocarbon | | Initial boiling point | (ASTM D86-05) |
| solvent C) | Type | (ASTM D86-05) [° C.] | [° C.] |
| Solvesso ® 200^{a)} | aromatic | 218 | 265 |
| Isopar ® K^{a)} | aliphatic | 178 | 197 |
| Isopar ® L^{a)} | aliphatic | 189 | 207 |
| Isopar ® M^{a)} | aliphatic | 223 | 254 |
| Soltrol ® 10^{b)} | aliphatic | 204 | 219 |
| Varsol ® 60^{a)} | aromatic | 195 | 245 |
| Varsol ® 80^{a)} | aromatic | 176 | 217 |

^{a)}Exxon-Chemie, Esso Deutschland GmbH
^{b)}Chevron Phillips Chem. Comp., USA
Preferred co-solvents C) are Isopar ® L, Isopar ® M, Soltrol ® 10, Varsol ® 60, Varsol ® 80, particular preference being given to Isopar ® L and Isopar ® M.

Following the copolymerisation of the monomers Ia) and Ib) for the preparation of the graft base I), the polymer II) is prepared by copolymerisation of the monomers IIa), IIb) and IIc) in the presence of the graft base I). The polymer P) contained in the polyacrylate dispersions according to the invention is obtained.

For neutralisation of the carboxyl groups polymerised in the polymer II), organic amines or water-soluble, inorganic bases can be used. Preference is given to N-methylmorpholine, triethylamine, dimethylethanolamine, dimethylisopropanol-amine, methyldiethanolamine, triethanolamine and ethyl-diisopropylamine. Diethylethanolamine, butanolamine, morpholine, 2-aminomethyl-2-methyl-propanol or isophoronediamine are likewise suitable.

The neutralising agent is added in amounts such that the degree of salt formation is from 70 to 130%, preferably from 90 to 105%, of the carboxyl groups, wherein the amount of neutralising agent added is particularly preferably such that free neutralising agent is still present after conversion of all the carboxyl groups into the salt form. This corresponds to a degree of neutralisation of >100%. It has been found that the dispersion stability, lacquer stability, pigment wetting and the film-optical properties can be markedly improved thereby.

The pH value of the aqueous dispersion is from 6.0 to 11.0, preferably from 7.9 to 10.0, and the solids content is from 35 to 65 wt. %, preferably from 40 to 55 wt. %.

The aqueous polyacrylate dispersions according to the invention are used in or as lacquer or coating compositions optionally together with other binders or dispersions, for example based on polyesters, polyurethanes, polyethers, polyepoxides or polyacrylates, in combination with crosslinker resins and optionally pigments and other auxiliary substances and additives known in the lacquer industry.

Before, during or after the preparation of the aqueous binder combinations by mixing the individual components, and also in the case of the preparation of coating compositions for processing in one-component form, auxiliary substances and additives conventional in lacquer technology can be added, such as, for example, antifoams, thickening agents, pigments, dispersing aids, catalysts, anti-skinning agents, anti-settling agents or emulsifiers.

The present invention likewise provides coating compositions comprising the aqueous polyacrylate dispersions according to the invention.

The coating compositions comprising the aqueous polyacrylate dispersions according to the invention are suitable for all fields of use in which aqueous painting and coating systems having an increased property profile are used, for example the coating of mineral building material surfaces, lacquering and sealing of wood and wood materials, coating of metal surfaces; coating and lacquering of asphalt- or bitumen-containing road coverings, lacquering and sealing of various plastics surfaces.

The lacquers or coating compositions based on the aqueous polyacrylate dispersions according to the invention are primers, fillers, pigmented or transparent finishing lacquers as well as single-layer lacquers, which can be employed in individual and series application, for example in the field of industrial lacquering, automotive initial and repair lacquering.

Preferred uses of the copolymers P) according to the invention dispersed and/or dissolved in water are in combination with polyisocyanates or, particularly preferably, in combination with mixtures of hydrophilic and hydrophobic polyisocyanates for the coating or lacquering of metal surfaces or plastics at room temperature to 180° C., or in combination with aminoplastic crosslinker resins for the coating and lacquering of metal surfaces at from 110 to 180° C. in the form of single-layer lacquers or in the form of finishing lacquers.

The production of the coating can be carried out by various spraying processes, such as, for example, compressed-air, airless or electrostatic spraying processes, using single- or optionally two-component spraying installations. The lacquers and coating compositions to be prepared and used according to the invention can, however, also be applied by other methods, for example by spreading, roller application or knife application.

### EXAMPLES

### Comparison Example 1

### Example 3 from EP 947 557

186 g of butyl glycol and 186 g of Solvesso® 100 (aromatic hydrocarbon, Exxon-Chemie, Esso Deutschland GmbH, initial boiling point (ASTM D86-05) 162° C.) were placed in a 6-litre reaction vessel equipped with a stirrer and a cooling and heating device, and heated to 145° C. At this temperature, a mixture 1) of 750 g of methyl methacrylate, 125 g of styrene, 445 g of hydroxyethyl methacrylate, 538 g of butyl acrylate and 87 g of butyl methacrylate was metered in over 3 hours and, immediately thereafter, a mixture 2) of 128 g of methyl methacrylate, 180 g of hydroxyethyl methacrylate, 100 g of butyl acrylate and 60 g of acrylic acid was metered in over 1.5 hours. In parallel therewith, a solution of 88 g of di-tert-butyl peroxide in 70 g of a 1:1 mixture of butyl glycol and Solvesso® 100 was metered in in the course of 5 hours. Stirring was then carried out for 2 hours at 145° C., followed by cooling to 100° C. and addition of 76 g of N,N-dimethylethanolamine. After 30 minutes' homogenisation, dispersion was carried out in the course of 2 hours at 80° C. with 2700 g of water. A dispersion having the following data was obtained:

| | |
|---|---|
| OH content (solid; calculated theoretically) | 3.3% |
| acid number (solid) | 20 mg KOH/g |
| solids content | 43.8% |
| viscosity | 1400 mPas_{23° C.} |
| pH value (10% in water) | 8.1 |
| degree of neutralisation | 105% |
| mean particle size | 110 nm |
| co-solvent | 7.7 wt. % |

### Example 2

372 g of Solvesso® 200 were placed in a 6-litre reaction vessel equipped with a stirrer and a cooling and heating device, and heated to 145° C. At this temperature, a mixture 1) of 750 g of methyl methacrylate, 125 g of styrene, 445 g of hydroxyethyl methacrylate, 538 g of butyl acrylate and 87 g of butyl methacrylate was metered in over 3 hours and, immediately thereafter, a mixture 2) of 128 g of methyl methacrylate, 180 g of hydroxyethyl methacrylate, 100 g of butyl acrylate and 60 g of acrylic acid was metered in over 1.5 hours. In parallel therewith, a solution of 88 g of di-tert-butyl peroxide in 70 g of Solvesso® 200 was metered in in the course of 5 hours. Stirring was then carried out for 2 hours at 145° C., followed by cooling to 100° C. and addition of 76 g of N,N-dimethylethanolamine. After 30 minutes' homogenisation, dispersion was carried out in the course of 2 hours at 80° C. with 2630 g of water. A dispersion having the following data was obtained:

| | |
|---|---|
| OH content (solid; calculated theoretically) | 3.3% |
| acid number (solid) | 20 mg KOH/g |
| solids content | 45.0% |
| viscosity | 1350 mPas_{23° C.} |
| pH value (10% in water) | 8.2 |
| degree of neutralisation | 105% |
| mean particle size | 110 nm |
| co-solvent | 7.7 wt. % |

### Example 3

372 g of Isopar® L were placed in a 6-litre reaction vessel equipped with a stirrer and a cooling and heating device, and heated to 145° C. At this temperature, a mixture 1) of 750 g of methyl methacrylate, 125 g of styrene, 445 g of hydroxyethyl methacrylate, 538 g of butyl acrylate and 87 g of butyl methacrylate was metered in over 3 hours and, immediately thereafter, a mixture 2) of 128 g of methyl methacrylate, 180 g of hydroxyethyl methacrylate, 100 g of butyl acrylate and 60 g of acrylic acid was metered in over 1.5 hours. In parallel therewith, a solution of 88 g of di-tert-butyl peroxide in 70 g of Isopar® L was metered in in the course of 5 hours. Stirring was then carried out for 2 hours at 145° C., followed by cooling to 100° C. and addition of 76 g of N,N-dimethylethanolamine. After 30 minutes' homogenisation, dispersion was carried out in the course of 2 hours at 80° C. with 2700 g of water. A dispersion having the following data was obtained:

| | |
|---|---|
| OH content (solid; calculated theoretically) | 3.3% |
| acid number (solid) | 22 mg KOH/g |
| solids content | 43.7% |
| viscosity | 1090 mPas_{23° C.} |
| pH value (10% in water) | 8.3 |
| degree of neutralisation | 105% |
| mean particle size | 115 nm |
| co-solvent | 7.7 wt. % |

### Example 4

372 g of Isopar® M were placed in a 6-litre reaction vessel equipped with a stirrer and a cooling and heating device, and heated to 145° C. At this temperature, a mixture 1) of 750 g of methyl methacrylate, 125 g of styrene, 445 g of hydroxyethyl methacrylate, 538 g of butyl acrylate and 87 g of butyl methacrylate was metered in over 3 hours and, immediately thereafter, a mixture 2) of 128 g of methyl methacrylate, 180 g of hydroxyethyl methacrylate, 100 g of butyl acrylate and 60 g of acrylic acid was metered in over 1.5 hours. In parallel therewith, a solution of 88 g of di-tert-butyl peroxide in 70 g of Isopar® M was metered in in the course of 5 hours. Stirring was then carried out for 2 hours at 145° C., followed by cooling to 100° C. and addition of 76 g of N,N-dimethylethanolamine. After 30 minutes' homogenisation, dispersion was carried out in the course of 2 hours at 80° C. with 2610 g of water. A dispersion having the following data was obtained:

| | |
|---|---|
| OH content (solid; calculated theoretically) | 3.3% |
| acid number (solid) | 19 mg KOH/g |
| solids content | 45.3% |
| viscosity | 1090 mPas_{23° C.} |
| pH value (10% in water) | 8.4 |
| degree of neutralisation | 105% |
| mean particle size | 105 nm |
| co-solvent | 7.7 wt. % |

### Example 5

372 g of Varsol® 60 were placed in a 6-litre reaction vessel equipped with a stirrer and a cooling and heating device, and heated to 145° C. At this temperature, a mixture 1) of 750 g of methyl methacrylate, 125 g of styrene, 445 g of hydroxyethyl methacrylate, 538 g of butyl acrylate and 87 g of butyl methacrylate was metered in over 3 hours and, immediately thereafter, a mixture 2) of 128 g of methyl methacrylate, 180 g of hydroxyethyl methacrylate, 100 g of butyl acrylate and 60 g of acrylic acid was metered in over 1.5 hours. In parallel therewith, a solution of 88 g of di-tert-butyl peroxide in 70 g of Soltrol® 10 was metered in in the course of 5 hours. Stirring was then carried out for 2 hours at 145° C., followed by cooling to 100° C. and addition of 76 g of N,N-dimethylethanolamine. After 30 minutes' homogenisation, dispersion was carried out in the course of 2 hours at 80° C. with 2630 g of water. A dispersion having the following data was obtained:

| | |
|---|---|
| OH content (solid; calculated theoretically) | 3.3% |
| acid number (solid) | 19 mg KOH/g |
| solids content | 44.9% |
| viscosity | 1130 mPas_{23° C.} |
| pH value (10% in water) | 8.1 |
| degree of neutralisation | 105% |
| mean particle size | 110 nm |
| co-solvent | 7.7 wt. % |

### Comparison Example 6

372 g of Isopar® V (aliphatic hydrocarbon, Exxon-Chemie, Esso Deutschland GmbH, initial boiling point (ASTM D86-05) 273° C.) were placed in a 6-litre reaction vessel equipped with a stirrer and a cooling and heating device, and heated to 145° C. At this temperature, a mixture 1) of 750 g of methyl methacrylate, 125 g of styrene, 445 g of hydroxyethyl methacrylate, 538 g of butyl acrylate and 87 g of butyl methacrylate was metered in over 3 hours and, immediately thereafter, a mixture 2) of 128 g of methyl methacrylate, 180 g of hydroxyethyl methacrylate, 100 g of butyl acrylate and 60 g of acrylic acid was metered in over 1.5 hours. In parallel therewith, a solution of 88 g of di-tert-butyl peroxide in 70 g of Isopar® V was metered in in the course of 5 hours. Stirring was then carried out for 2 hours at 145° C., followed by cooling to 100° C. and addition of 76 g of N,N-dimethylethanolamine. After 30 minutes' homogenisation, dispersion was carried out in the course of 2 hours at 80° C. with 2450 g of water. A dispersion having the following data was obtained:

| | |
|---|---|
| OH content (solid; calculated theoretically) | 3.3% |
| acid number (solid) | 19 mg KOH/g |
| solids content | 48.5% |
| viscosity | 1160 mPas_{23° C.} |
| pH value (10% in water) | 8.4 |
| degree of neutralisation | 105% |
| mean particle size | 110 nm |
| co-solvent | 7.7 wt. % |

### Application Examples

### A to F

Clear lacquers were formulated in accordance with the table below and applied by means of a graduated doctor blade. The blister limit was determined visually after exposure to air for 30 minutes.

| Amounts used | | | | | | |
|---|---|---|---|---|---|---|
| in grams | A | B | C | D | E | F |
| Example 1 | 514 | | | | | |
| Example 2 | | 500 | | | | |
| Example 3 | | | 515 | | | |
| Example 4 | | | | 497 | | |
| Example 5 | | | | | 500 | |
| Example 6 | | | | | | 464 |
| Surfynol ® 104 BC | 11.3 | 11.3 | 11.3 | 11.3 | 11.3 | 11.3 |
| Borchigel ® PW25 | 1.5 | 1.5 | 1.5 | 1.5 | 1.5 | 1.5 |
| Baysilon ® VP AI 3468 | 9.4 | 9.4 | 9.4 | 9.4 | 9.4 | 9.4 |
| Bayhydur ® VP LS 2319 | 191.1 | 191.1 | 191.1 | 191.1 | 191.1 | 191.1 |
| 80% in ® Butoxyl | | | | | | |
| Water | 31 | 45 | 30 | 48 | 45 | 91 |
| Blister limit [μm] | 60 | 80 | 90 | 130 | 100 | 65 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous polyacrylate dispersions comprising copolymers P) which are comprised of
I) a hydroxy-functional, hydrophobic polymer containing as structural monomers
Ia) (meth)acrylic acid esters having from C₁- to C₁₈-hydrocarbon radicals in the alcohol part and/or vinyl aromatic compounds and/or vinyl esters and
Ib) hydroxy-functional monomers; and
II) a hydroxy-functional, hydrophilic polymer containing as structural components
IIa) (meth)acrylic acid esters having from C₁- to C₁₈-hydrocarbon radicals in the alcohol part and/or vinyl aromatic compounds and/or vinyl esters,
IIb) hydroxy-functional monomers and
IIc) acid-functional monomers,
and as solvents C) one or more solvents selected from the group consisting of hydrophobic, water-immiscible hydrocarbons having an initial boiling point of from 170° C. to 250° C. and a dry point of from 200° C. to 280° C.

2. Aqueous polyacrylate dispersions according to claim 1, wherein the water-immiscible hydrocarbon has an initial boiling point of from 180° C. to 230° C. and a dry point of from 200° C. to 260° C.

3. Aqueous polyacrylate dispersions according to claim 1, wherein the proportion of the monomers Ia)/IIa) in the copolymer P) is from 23 to 89.4 wt. % and the proportion of the monomers Ib)/IIb) in the copolymer P) is from 10 to 65 wt. % and the proportion of the monomers IIc) in the copolymer P) is from 0.6 to 12 wt. %.

4. Aqueous polyacrylate dispersions according to claim 1, wherein the acid-functional monomers IIc) are used in an amount such that the copolymer P) has an acid number of from 5 to 55 mg KOH/g solid.

5. Aqueous polyacrylate dispersions according to claim 1, wherein the proportion of the hydroxy-functional, hydrophobic graft base I) in the copolymer P) is from 50 to 95 wt. % and the proportion of the hydroxy-functional, hydrophilic copolymer II) in the copolymer P) is from 5 to 50 wt. %.

6. Process for the preparation of the aqueous polyacrylate dispersions according to claim 1, the process comprising the steps of:
in a first step (i) a hydroxy-functional, hydrophobic graft base I) having an OH number of from 12 to 250 mg KOH/g solid is prepared from the monomers Ia) and Ib),
in a second step (ii) the hydroxy-functional, hydrophilic polymer II) is prepared from the monomers Ia) to IIc) in the solution of the graft base I) obtained from step (i), wherein said hydroxy-functional, hydrophilic polymer has an OH number of from 20 to 250 mg KOH/g solid and an acid number of from 50 to 250 mg KOH/g solid,
where step (i) and (ii), the free-radical-initiated copolymerisation of the monomer mixture I) and II) take place in one or more co-solvents C),
iv) the neutralising agent for producing the ionic groups necessary for the dispersion is added after the copolymer preparation, followed by
v) a dispersing step of adding water to the copolymer P) or transferring the copolymer P) into water.

7. Aqueous coating compositions comprising polyacrylate dispersions according to claim 1.

8. Primers, fillers, pigmented or transparent finishing lacquers as well as single-layer lacquers, automotive initial and repair lacquers comprising the polyacrylate dispersions according to claim 1.
